(19) United States
(12) Patent Application Publication
(10) Pub. No.: US 2022/0367982 A1
(43) Pub. Date: Nov. 17, 2022

(54) Battery Module, Components, and Method of Assembly

(71) Applicant: American Battery Solutions, Inc., Springboro, OH (US)

(72) Inventors: Josh Payne, Oakland Township, MI (US); Matthew Knoche, Clarkston, MI (US); Michael Paul Garascia, Waterford, MI (US); Jean-Paul Ortiz, Rochester Hills, MI (US); Erik Anderson, Troy, MI (US)

(73) Assignee: American Battery Solutions, Inc.

(21) Appl. No.: 17/319,170

(22) Filed: May 13, 2021

(51) Int. Cl. H01M 50/516; H01M 50/543; H01M 10/42; H01M 50/533; H01M 50/244

(52) U.S. Cl. CPC H01M 50/516; H01M 50/543; H01M 10/425; H01M 10/4207; H01M 50/533; H01M 50/244; H01M 2010/4271; H01M 2220/20

(57) ABSTRACT

An improved battery module and methods of assembly are disclosed. A battery module may include carriers for holding battery cells via interference fit. The carriers may include a busbar with a stamped fusible link between each battery cell and the busbar. The battery module may be held together via interference fit, laser welding, and friction welding. A method of assembly may electrically and mechanically connect battery cells by laser welding stamped fusible links within a busbar. The method may further enclose the battery cells within a case and create a seal between the lid and case using friction welding.

### TECHNICAL FIELD

The disclosed embodiments generally relate to battery modules, components therefor, and methods of assembly of battery modules for commercial applications.

### BACKGROUND

Use of Original Equipment Manufacturer (“OEM”) Lithium-ion batteries for industrial applications is increasing. Historically, lead acid batteries have dominated commercial applications for batteries. Industrial applications and uses of OEM batteries include powering material handling equipment such as forklifts, scissor lifts, and robots; powering transportation vehicles (i.e., light electric vehicles such as golf carts, and heavier vehicles including cars); and diesel generator sets for stationary power applications. Conventional batteries for use in industrial applications assume multiple different form factors and chemistries including, without limitation, lead-acid, nickel metal hydride (“NiMH”), and Lithium Ion (LFP, NMC, etc.). This wide array of architectures and chemistries has resulted in a wide variety of sizes and shapes of batteries, as well as connecting multiple batteries in series to achieve higher effective voltage. This in turn involved multiple battery assemblies, connectors, connections, and increased bill of materials. Prior approaches modularize batteries in small units, requiring multiple external connectors and connections which increases the space occupied by the modules and decreases durability. This has produced applications in which multiple components are connected through external connections, increasing the size, volume, and weight of the battery assemblies as well as requiring constant maintenance. Further, many parts and connections may be exposed to environmental insult and degradation severely limiting marine use and decreasing the lifecycle of the connections and the battery modules. Conventional modules are typically configured to provide 24V, 36 V, or 48 V.

Thus, there is a need for an improved battery module that is compact, has high energy density, high capacity utilization, robust, offers a lower total cost of ownership, reduces the overall bill of materials, and is fully integrated within a single module. Providing a module with a compact form factor and a higher energy density will decrease the space occupied by the module while increasing available energy. With higher capacity utilization, cycle life may be increased by utilizing more of the available energy with a deeper depth of discharge and longer life. Compact, fully integrated modules are also more robust with a longer cycle life, require little or no maintenance due to failures of interconnections between modules, and fewer components, all of which would decrease the total cost of ownership.

There is also a need for improvements over current lithium-ion battery modules by integrating monitoring, measurement, and control functions into a single circuit board without requiring a separate housing which is separately wired back into a busbar.

There is also a need to improve conventional methods of assembling battery modules to produce modules with a more compact form factor, more concise design, integrated structure, reduced bill of materials, improved robustness to the elements (resilience to water submersion, spray, dust, etc.), increased reliability, and increased flexibility in use.

Known methods of assembling battery modules typically involve substantial bills of materials and multiple assembly and attachment steps. The use of multiple fasteners, connectors, wire bolds, fillers, and structural components results in multiple parts that may be susceptible to fatigue, loosening, damage, or failure from vibration of even normal usage. Improved methods of assembling battery modules would eliminate the need for and use of multiple fasteners within the module. Improved methods of assembling battery modules will consolidate and integrate design and structure of the module by removing the need for fillers as well as eliminating loose wires and soldered connections. By using welded connections, the module will be more robust and more resistant to corrosion, vibration, and shock. These improvements will also reduce if not eliminate the need for multiple fasteners and connectors, including bolts, nuts, and screws, and in favor of the of simpler and more reliable materials, thus, reducing the overall bill of materials.

The improved methods of assembly disclosed herein also provide for the use of an integrated battery management system (“BMS”). A BMS may be mounted within the case of the battery module, further decreasing the number of components and attachments and minimizing the form factor over conventional methods. These conventional known methods typically use a separate box that requires attachment to the module or the application housing, as well as separate electrical and communication wired between the module and the BMS. These improvements help to make the battery module more water and dust resistant and may assist in meeting ISO Standard IP67. The improved methods also allow for flexibility to adapt to voltage or power requirements while utilizing the same components within the same form factor.

Disclosed embodiments may include an unconventional battery module, improved components, and methods of assembling battery modules. As compared to prior known solutions, embodiments of the present disclosure may provide an improved battery module that is compact, has a higher energy density, has higher capacity utilization, is robust, reduces the cost of ownership, and is fully integrated within a single module. Other embodiments may include methods of assembling battery modules to produce modules with more compact form factors, more concise designs, integrated structures, reduced bill of materials, integrated building management systems, ISO Standard IP 67 compliance, increased reliability, and increased flexibility in use.

### SUMMARY

Embodiments of the present disclosure include an improved battery module, components, and methods of assembly for an improved battery module. Consistent with disclosed embodiments, a battery module is provided comprising a first carrier configured to hold an end of each cell of a plurality of battery cells; a second carrier configured to hold another end of each cell of the plurality of battery cells; a case partially enclosing the first carrier and the second carrier; a first busbar cooperating with the first carrier; a second busbar cooperating with the second carrier; and a lid fully enclosing the first carrier and the second carrier.

Consistent with disclosed embodiments, a method for assembling a battery module may include inserting a plurality of battery cells in a first carrier; holding the plurality of battery cells between the first carrier and a second carrier; connecting one end of each of the battery cells to a first busbar integrated within the first carrier; connecting another end of each of the battery cells to a second busbar integrated within the second carrier to form a brick; connecting a battery management system (BMS) with the interior of a case; pressure fitting the brick into the case; connecting the brick to a positive terminal and negative terminal by connecting the first busbar to the first terminal and the second busbar to the second terminal; connecting the first terminal and the second terminal to the BMS; and attaching a lid onto the case. Depending on the orientation of the cells, the first terminal can be a positive or negative terminal, and the second terminal can be the other of a positive or negative terminal.

Advantages of the disclosed embodiments will be set forth in part in the description which follows, and in part will be obvious from the description, or may be learned by practice of the disclosed embodiments. The advantages of the disclosed embodiments maybe realized and attained by means of the elements and combinations particularly pointed out in the appended claims.

It is to be understood that both the foregoing general description and the following detailed description are exemplary only and are not restrictive of the claimed embodiments.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a perspective view of battery cells inserted into carrier, according to an embodiment.

FIG. 2A is a top view of carrier with integrated busbar and stamped fusible links, according to an embodiment.

FIG. 2B is a bottom view of carrier with integrated busbar and stamped fusible links, according to an embodiment.

FIG. 3 is a perspective view of a brick, according to an embodiment.

FIG. 3A is an exploded view of brick, according to an embodiment.

FIG. 4 is a perspective view of a brick position in a battery case, according to an embodiment.

FIG. 5 is an enlarged view of a terminal connection, according to an embodiment.

FIG. 6 is a perspective view of a battery module, according to one embodiment.

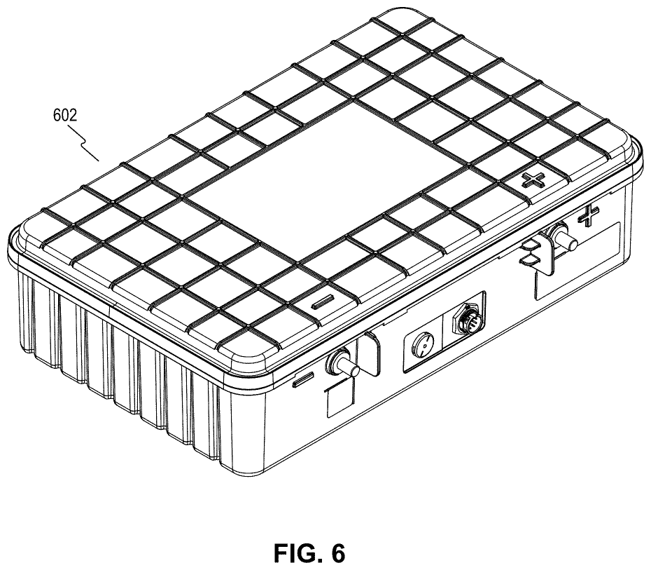

FIG. 7 is a flow chart showing the basic steps for assembling a battery module, consistent with disclosed embodiments.

FIG. 8A is an enlarged view of stamped fusible link and weld pattern, according to an embodiment.

FIG. 8B is an enlarged view of stamped fusible links and weld patterns, according to an embodiment.

FIG. 9 is an exploded view of an embodiment of battery module assembly of the present disclosure comprising a lid, brick, BMS, and case.

FIG. 10 is a bottom view of lid, according to an embodiment.

FIG. 11 is an exemplary circuit diagram, according to an embodiment.

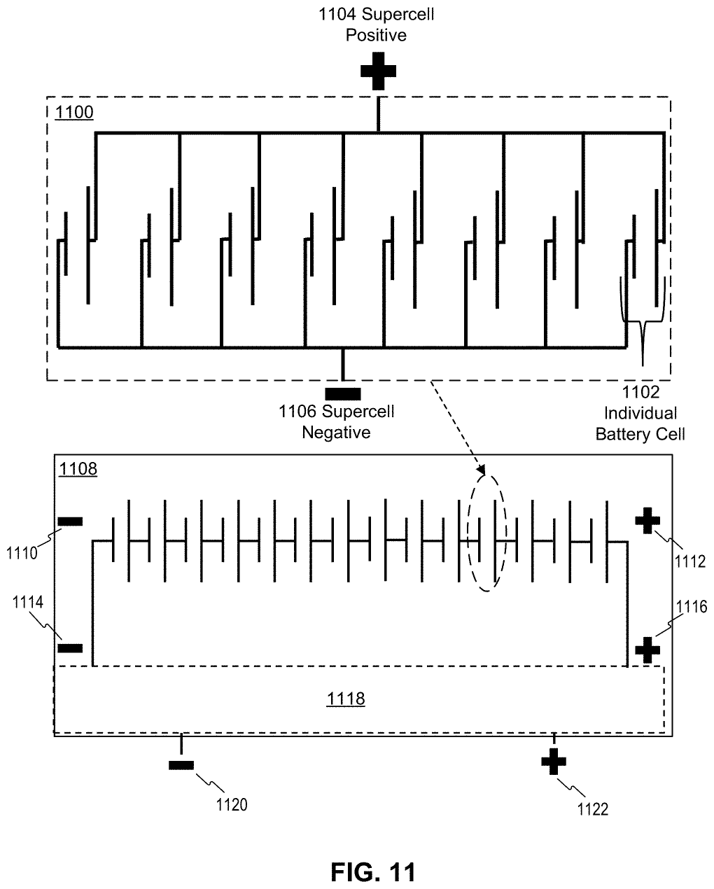

### DESCRIPTION OF THE EMBODIMENTS

Embodiments consistent with the present disclosure may include a battery module. A battery module may include a fixed number of battery cells and a battery assembly housed in a container to protect the cells from external shock, heat, or vibration. Battery cells may be cylindrical or prismatic. A battery module may provide a nominal voltage of 24 V, 36 V, 48 V, or any other suitable voltage according to device or product specifications. Additionally or alternatively, a battery module may be configured to provide a non-standard nominal voltage, according to device or product specifications.

A battery cell may include a basic unit of a lithium-ion battery that provides electric power by charging and discharging. The battery cell may be made by inserting cathode, anode, and separator, and electrolyte into a case. Battery cells may be produced in a variety of chemistries, such as lithium-ion iron phosphate (LFP), lithium-ion nickel manganese cobalt (NMC), lithium-ion nickel manganese cobalt aluminum (NMCA), or any other suitable combination of elements suitable for use in a battery module to receive, produce, or store electric energy.

In certain embodiments, battery cells may be cylindrical. Cylindrical battery cells are widely used and readily available. Advantageously, cylindrical battery cells may be easier to manufacture and mechanically stable. The cylindrical shape may withstand high internal pressures without deforming. Cylindrical battery cells may have a positive terminal at one end, and a negative terminal at the other. Cylindrical battery cells may vary in size and capacity according to their chemistry, process of manufacture, and functional requirements. Cylindrical battery cells sizes may include 18650, 21700, 26650, or other sizes conforming to industry standards or individual product design.

In another embodiment, the battery cells may be prismatic. Prismatic cells may be produced in a range of sizes and shapes, as there is currently no industry standard, allowing manufactures to design prismatic battery cells to meet individual needs and specifications. Prismatic cells may also be interconnected by a busbar in series or parallel to a BMS and, to the battery terminals.

Individual battery cells may be produced or obtained from a battery cell supplier. Each individual cell has a positive terminal and a negative terminal. The battery cells may be delivered as an individual cell holding a partial charge, such as a 30% charge. The cells may be inspected for visual defects, AC impedance (ACIR), and voltage to ensure no damage or issues have occurred during shipping or transport and that the cells meet the cell supplier's and manufacturer's specifications.

A battery module may include multiple cells connected in series and/or parallel. The connections may be monitored and regulated by sensors and controllers within the battery module. The sensors and controllers may be electrically or mechanically connected to a battery management system (“BMS”). A BMS may include cutoff circuitry, a fuel gage monitor, cell voltage monitor, cell voltage balance, real-time clock, temperature monitor, a state machine, or any other component for managing output, charging, and discharging of a battery module in order to protect the battery cells in operation as well as a user of the battery module. The BMS may use MOSFET circuitry to manage the battery cells. The BMS may also be configured to provide notifications regarding the status of the battery module such as the charge status. The notifications may be delivered from the BMS to the vehicle via the CAN connector for interpretation and display by the vehicle.

The BMS may be included within the casing of the battery module according to device or product specification. In certain embodiments, the BMS may be mounted within the casing on the bottom, below the battery cells. In other embodiments, the BMS may be mounted above the battery cells or attached to the inside of the battery module lid. In further embodiments, the BMS may be mounted on a side of the casing such that the BMS is oriented parallel to the axes of the batteries.

The battery cells 102, 312 may be interconnected through first and second busbars. Busbars 204, 252, 304, 320, 404, 802 may include a metallic strip or bar that conducts electricity. Busbars 204, 252, 304, 320, 404, 802 may be manufactured using nickel-steel, copper, aluminum, or any other suitable material that is electrically conductive. Individual battery cells may be connected to the busbar which may also be connected to BMS and, thereby, battery terminals 412, 504, 918 . The busbar may be configured so that the battery cells are connected in series and/or parallel.

In some embodiments, busbar 204, 252, 304, 320, 404, 802 may be manufactured as a single sheet, providing connections between busbar and cells. In other embodiments, busbar may be manufactured as multiple plates

In some embodiments, busbar 204, 252, 304, 320, 404, 802 may provide a connection between individual cells 1102 or groups of cells (e.g., a supercell) 1104 in parallel and or/series. In one example, busbar 204, 252, 304, 320, 404, 802 may connect set or group of individual cells 1102 in parallel, forming supercell 1104. Busbar 204, 252, 304, 320, 404, 802 may further connect supercells 1104 in parallel. Positive terminal 1112 of supercells 1104 may connect to internal positive BMS input 1116 of BMS 1118. Negative terminal 1110 of supercells 1104 may connect to internal negative BMS input 1114 of BMS 1118. It will be appreciated that multiple configurations of connections and cells may be apparent to a person of skill in the art according to the desired power and voltage and the number and size of cells available which meet the appended claims to their equivalence.

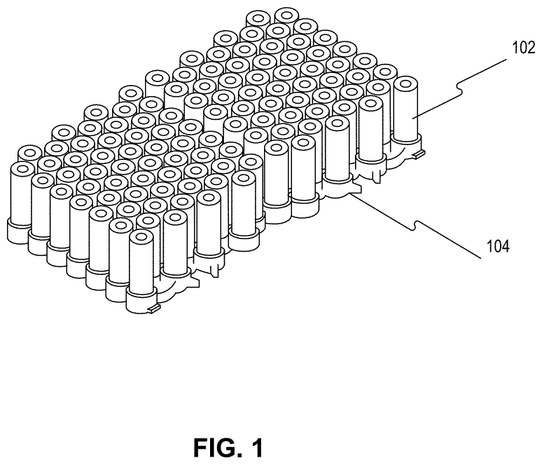

Consistent with the disclosed embodiments, battery module may include one or more carriers 104, 202, 250, 310, 316. Carrier 104, 202, 250, 310, 316 may include casing, shell, or other housing configured to hold or position battery cells or provide structure. By way of example, FIG. 1 shows battery cells 102 held in position by carrier 104. First carrier 104, 250, 316 may include first busbar 252, 320 and may be connected to battery cells 102, 312. In some embodiments, busbar 204, 252, 250, 310, 316, 404, 802 may be integrated within carrier 104, 202, 250, 310, 316. A first carrier 104, 250, 316 may include first busbar 250, 320 that connects battery cells 102, 312 in series or parallel through leads 208, 254, 306, 322, 406 to BMS 410, 502, 912. Cells 102, 312 may be held in place by interference fit into carriers while the terminals of each cell are mechanically and electrically connected to first busbar 252, 320 in first carrier 104, 250, 316 by laser welding.

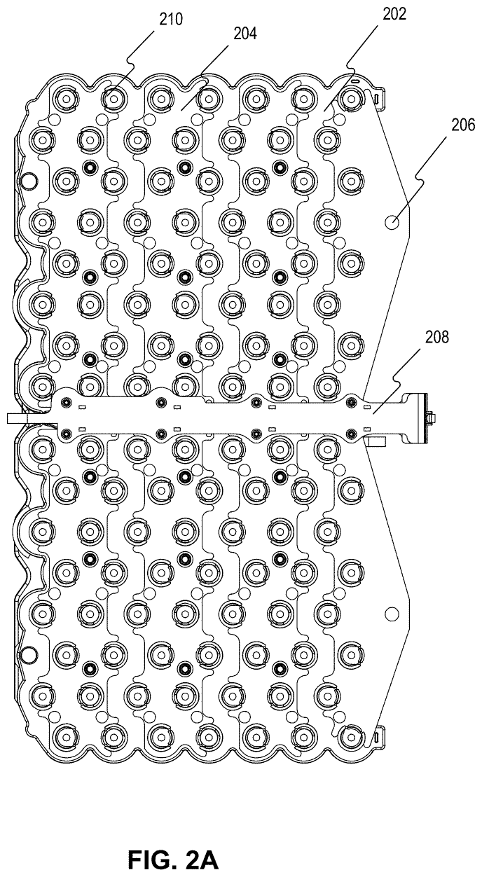

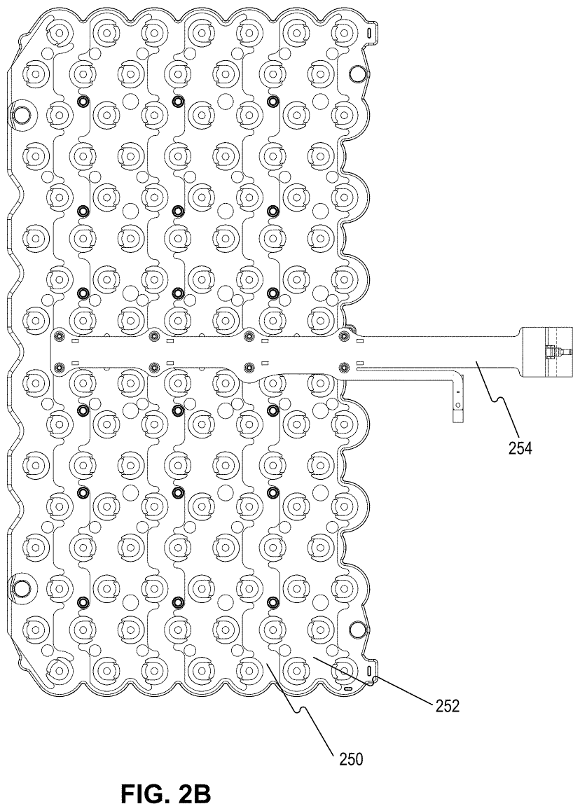

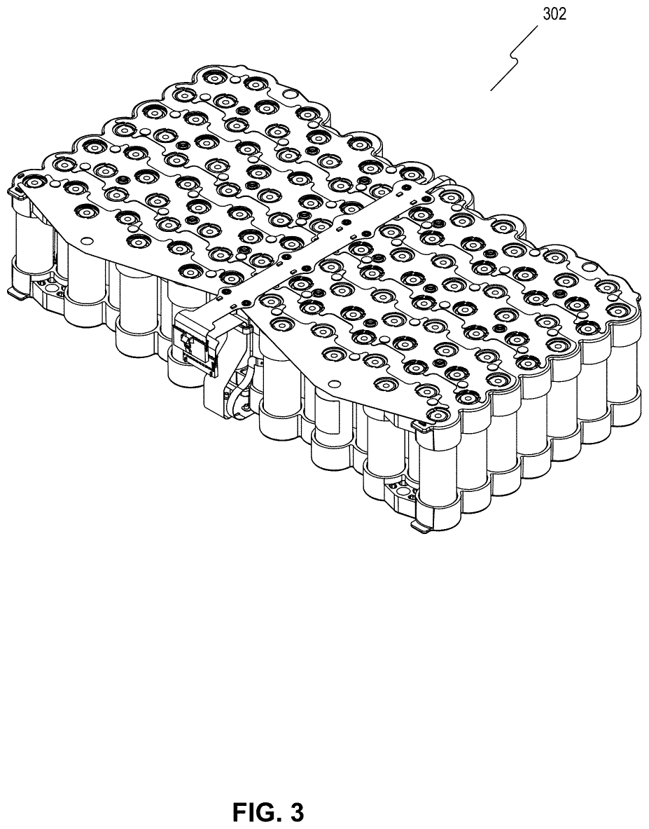

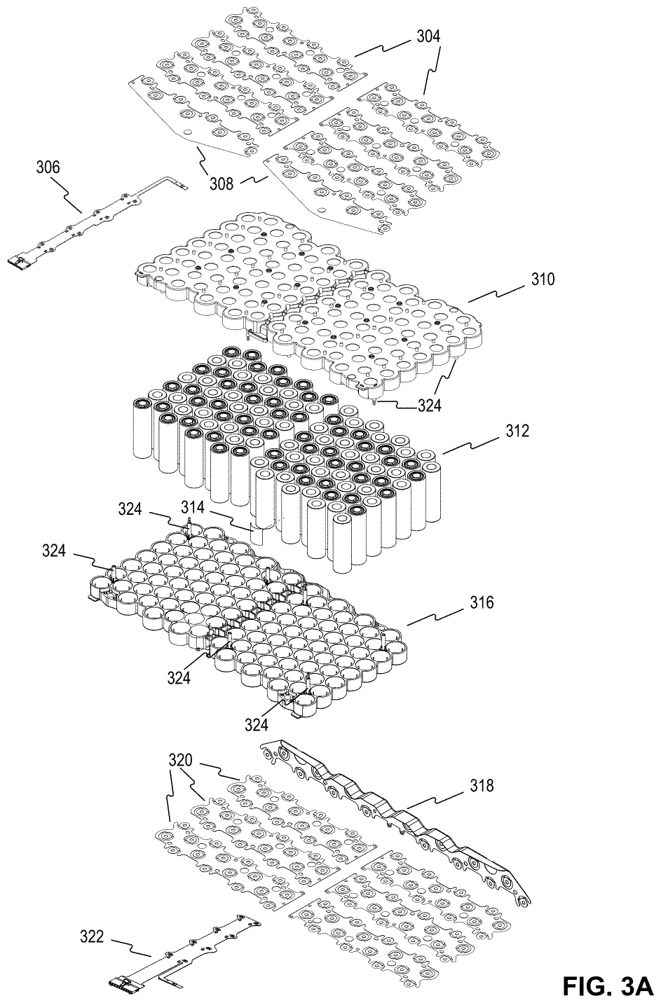

Second carrier 202, 310 may include second busbar 204, 404, 508, that connects battery cells 102, 312 in series and/or parallel with leads 414 through the BMS. Cells 102, 312 may be held in place by interference fit while the terminals of the cells are mechanically and electrically connected to second busbar 204, 404, in second carrier 202, 310 by laser welding. By way of example, FIG. 2A shows a top view of a carrier 202 with busbar 204 integrated into the structure of carrier 202. As depicted in FIG. 3, the combination of first carrier 104, 250, 316, first busbar 252 connected to battery cells 102, 312, connected to second carrier 202, 310 and second busbar 204, 404, 508, connected to cells 102, 312 may be referred to herein as brick 302 (i.e., a brick of cells).

Disclosed embodiments may include busbar 204, 252, 304, 320, 404, 802 comprising stamped fusible links 210, 804. Busbar 204, 252, 250, 310, 316 may comprise different suitable materials and coatings. Busbar 204, 252, 304, 320, 404, 802 may be mechanically and electrically connected to battery cells 102, 312 to form subgroups of battery cells connected in series and/or parallel. The subgroups of battery cells may be connected by busbar 204, 252, 250, 310, 316 in series and/or parallel with other subgroups of battery cells 102, 312.

During normal operation, fusible link 804 may carry current from cells 102, 312 to busbar 204, 252, 304, 320, 404, 802 through fusible link 804 and land 812. Fusible link 804 may serve as a fuse to sever the connection between an individual cell and busbar 204, 252, 304, 320, 404, 802 at a an appropriate current flow level. This may enhance safety by preventing combustion or a thermal event. Specifically, the fusible link 804 may melt and disconnect battery cell 102, 312 from busbar 204, 252, 304, 320, 404, 802 and, thus, remaining cells. This design can be tailored for any voltage and desired current performance. The precise parameters of the fusible link can be controlled by varying the shape, thickness, width, and material composition of the stamped fusible link 804.

Fusible link 804 may be integrally formed within busbar 204, 252, 304, 320, 404, 802. The structure of the link 804 may be varied to meet a variety of functional, performance, or safety requirements according to individual product design and use.

Fusible links in prior known batteries are traditionally wire or ribbon bonds to join the busbar to the cell as a fuse. Wire bond components in prior known systems were typically physically separate from the busbar element. Multiple alternative shapes and fusible link designs may perform the same function. A person of skill in the art would understand that the shape of the stamped fusible link may depend on individual specifications, such as variances among cells, fusing characteristics, materials, cells types, process of manufacture, and intended use. For example, FIG. 2 shows a carrier 202 which includes a stamped fusible link 210 for connecting a busbar 204 to individual battery cells (not show).

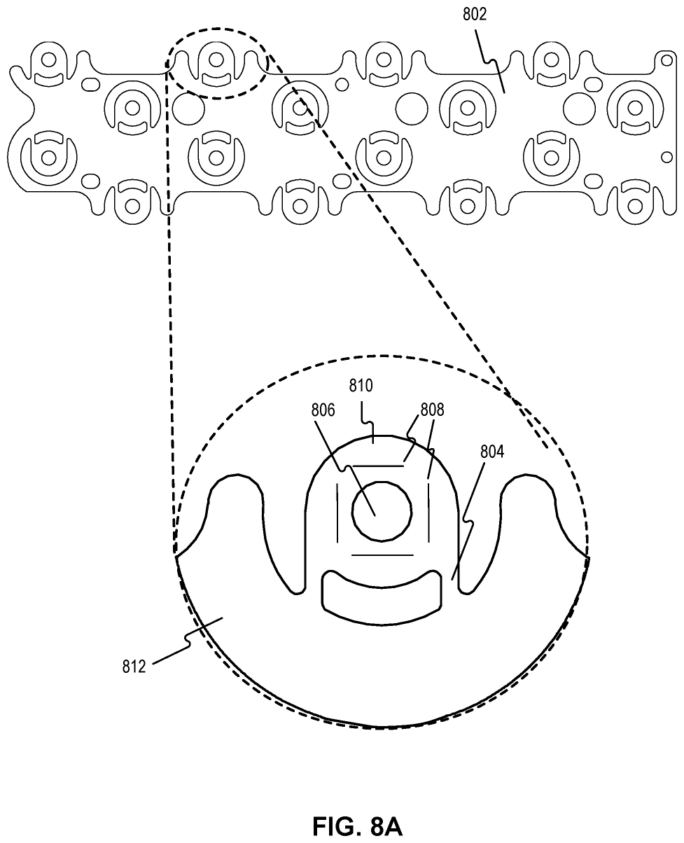

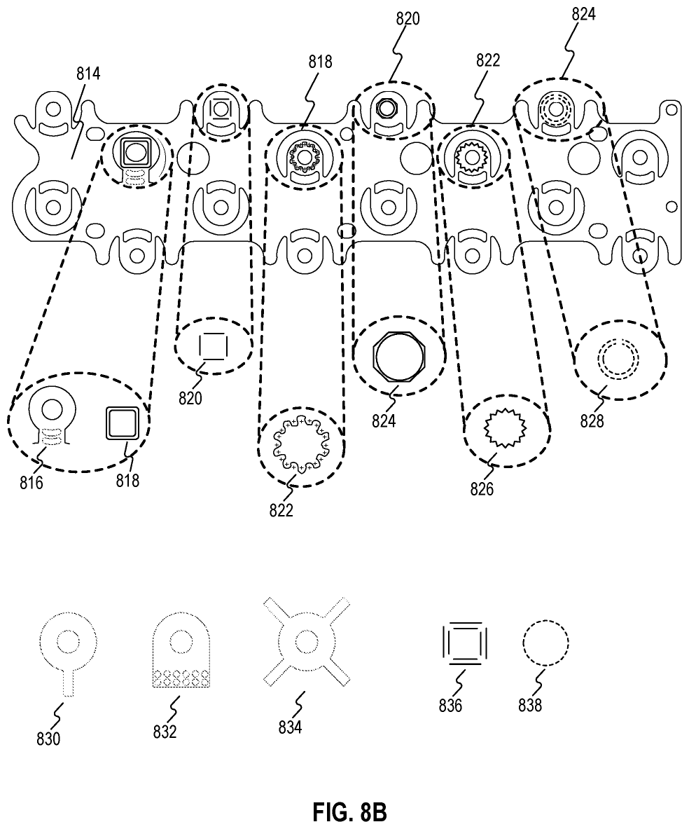

Stamped fusible links 210, 804 may increase the safety of the battery overall. Fusible links 210, 804 may providing fuse functionality to the stamped metal busbar 204, 252, 304, 320, 404, 802 without the need for specialized processes or additional parts such as wire or ribbon bonding, which may introduce the potential for substantial variances and errors. Fusible links 210, 804 may be connected to the terminals of battery cells 102, 312 using either resistance or laser welding, which may provide substantially increased functionality with fewer components and a smaller bill of materials and cost. FIG. 8A is an exemplary busbar 802 with stamped fusible link 804 serving as fuse. FIG. 8B includes additional exemplary shapes of a fusible link 816, 830, 832, 834.

Consistent with disclosed embodiments, dialectic, fire retardant sheet, such as FORMEX®, may cover busbar 204, 310, 404. The sheet may be improve safety and stability of the module assembly. For example, the sheet may be VO compliant according to the plastics flammability standard released by Underwriters Laboratories (UL-94), providing some fire-retardant capability. The sheet may also be inserted to isolate internal components to prevent damage.

Consistent with disclosed embodiments, an outer case component 402, 914 may be configured to partially enclose the internal, interconnected components. Additionally, the internal shape of the case 402, 914 may be configured in order to hold carrier 104, 202, 250, 310, 316, battery cells 102, 312, BMS 410, 502, 912, or other internal component by interference fit. Alternatively, other suitable fastening methods may be used.

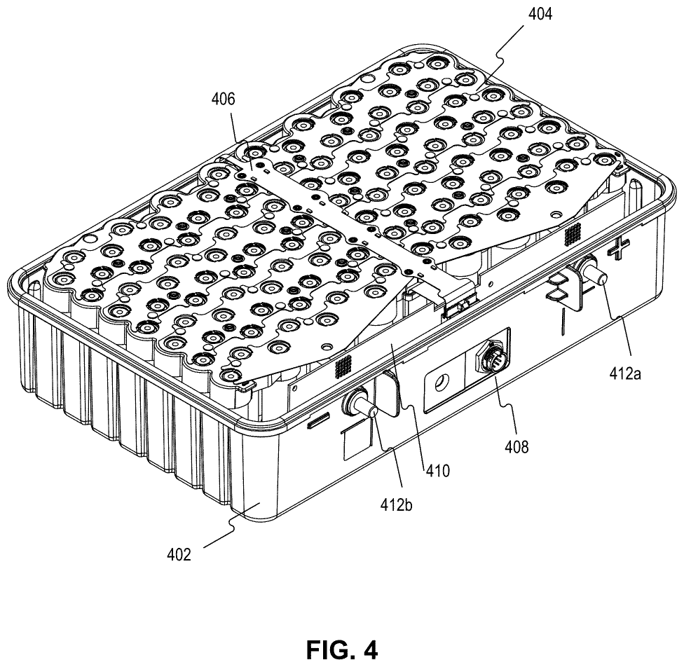

Consistent with disclosed embodiments, a board with circuitry configured as a BMS 410, 502, 912 may be included as part of the module. The board may be obtained (from a supplier or prefabricated) and connected to the busbars 204, 252, 304, 320, 404, 802. For example, FIG. 4 shows BMS board 410 connected to the busbars 404 with a 90-degree angle between the busbar 404 and the BMS board 410. BMS 410 may be fitted against an outer edge of case with terminals 412 extending through and beyond case 402. BMS 410 may also include low voltage connection 408, such as a controller area network (“CAN”) connector, for external communication between battery module and a vehicle or other battery modules. Low voltage connection 408 may conform to vehicle bus design standards and allow communication between the battery module and a host vehicle without a host computer. The board size, shape, and configuration may vary with design specifications, preferences, and material.

Consistent with disclosed embodiments, busbars 204, 252, 304, 320, 404, 802 may connect cells or groups of cells 102, 312 in series and/or parallel. Additionally, busbars 204, 252, 304, 320, 404, 802 may connect to BMS 410, 502, 912 via a positive and negative input terminal 412, 504, 918. Terminals 412, 504, 918 may be integral to BMS 410, 504, 918. In one embodiment, input terminals may extend from BMS 410, 502, 912 for connection between busbars 204, 252, 304, 320, 404, 802 and BMS 410, 502, 912. Terminals 412, 504, 918 may be integrated with BMS 410, 502, 912 during production of BMS 410, 502, 912 or assembly of the module.

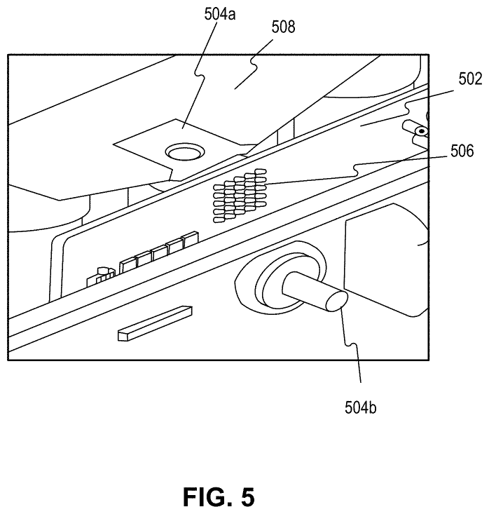

In some embodiments, one end of terminal 504a may be block shaped to facilitate connection to busbar 508 via welding or fastener while the other end of the terminal may be attached to BMS 502 by extending multiple points of contact 506 through BMS 502 from one side to the other, as depicted in FIG. 5. The points of contact 506 may take any suitable shape. In this example, multiple points of contact 506 are arranged in a 5 by 5 gird. Multiple points of contact may provide a joint or connection with low resistance while also providing a strong mechanical joint.

Consistent with disclosed embodiments, low voltage connection port 408 may extend through the wall of the outer battery module housing 402. Low voltage connection port 408 may be secured by interference fit or other suitable fastener. If a fastener is used, fastener may be torqued according to product and design specifications. An O-ring or other sealing component (not shown) may also be included on the interior of the case between the interior of the case and the port 408 in order to provide a seal between the interior and exterior of the battery module.

Consistent with disclosed embodiments, the positive terminal 412a, 918a and negative terminal 412b, 918b may attach to the internal components, including BMS 410, 912. As terminals 412, 918 extend through the body of the case 402, 914, an O-ring, gasket, sealant, or other components provide a seal between the interior of the case and the exterior environment. Terminals 412, 918 may be held in place by interference fit between the terminal, case, and BMS. Alternatively, the terminal may be designed as a threaded fastener in order to hold the terminal in place and connected to the interior components while also providing a secure external connection. For example, positive terminal 412a extends through the body of case 402.

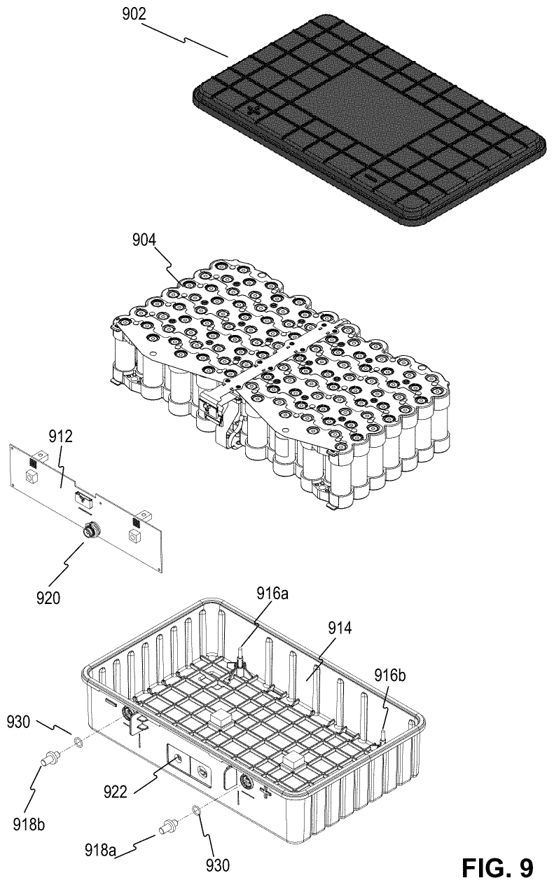

Consistent with disclosed embodiments, brick 302, 904 may be inserted into case 402, 914 by applying force to mate brick onto posts 916 in case 914 so that the components are held in place by interference fit. Brick 302, 904 is thereby mechanically joined to case 402, 914. Posts 916 may include features integral to the inside of the case 402, 914 for aligning battery module components. Posts 916 may provide structural support. As depicted in FIG. 9, posts 916 guide brick 904 into position within battery case 914. Posts 916 interact with brick 904 to hold it in place via interference fit.

Consistent with disclosed embodiments, sensing circuit leads 208, 254, 306, 322, 406, such as flex, wire, or piezoelectric, may be attached to positive terminal 412a, 918a and negative terminal 412b, 918b of each battery cell 102, 312, group of cells, or busbar 204, 252, 304, 320, 404, 802 to facilitate monitoring, measuring, and control by BMS 410, 502, 912. Additional sensing circuit leads may be used to sense or measure voltage at the positive or negative end of each set of parallel cells. By way of example, sensing lead 208 in FIG. 2A connects to busbar 204.

Consistent with disclosed embodiments, safety features or components may be included to enhance safety in handling module. For example, MOSFETs in BMS 410, 502, 912 connected to the external terminals can be configured to cause an open circuit when not in use or during assembly or transport, so that no voltage is applied to the external terminals in these conditions. MOSFETs (not shown) may be controlled by BMS using appropriate algorithms based on various including, without limitation, module voltage, cell voltages, current, temperature, state of charge, differences in voltages of one cell group to another, differences in temperature of one cell group to another, internal pressure within the case, presence of absence of certain gasses in the module, or any other information available to the BMS. Additional safety features may include the fusible links disclosed herein, a current interruption device included within each cell, and a portion of the busbar that may act as a fuse in the event that the battery module is subjected to excessively high current.

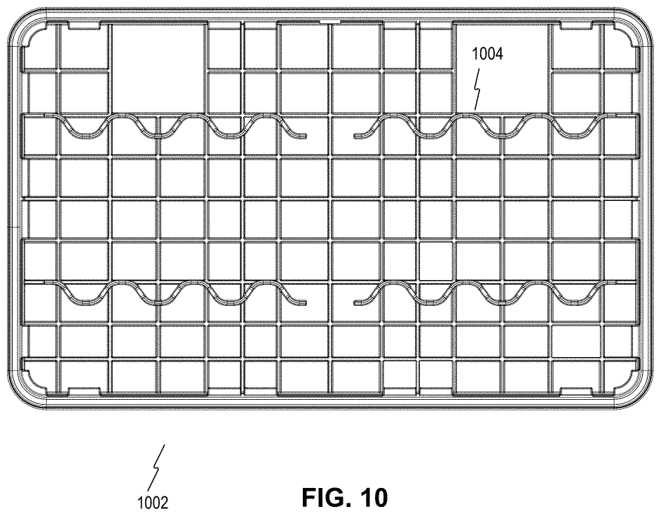

Consistent with disclosed embodiments, the battery module may include a lid connected to the body of the case thereby enclosing the battery module. Lid 902, 1002 may be attached to case 914 by frictional welding. Case may be held so that bottom 914 remains stationary while top 902 is applied and, while in contact with the case, vibrates at a frequency of about 80 Hz. The top and bottom components of case are precisely aligned such that there is substantial area of contact along the perimeter of the components with the contact accruing in a substantial area suitable for frictional welding to form. The resulting friction weld may provide a very reliable and robust connection along the perimeter of the top and bottom case components. Preferably, the vibrational weld will be continuous and eliminate the need for additional seals or other components while ensuring a hermetic, if not a watertight, seal. The friction weld may also connect features on the interior of the lid with the brick. For example, features 1004 in FIG. 10 may be connected to the top of brick 302, 904 by friction welding. In some embodiments flash traps may be used.

Frictional welding concurrently seals the battery enclosure case and lid while retaining or holding the brick in place by welding the first cell carrier to specifically designed features on the inner surface of the lid or base in a single process, eliminating the need for threaded fasteners, adhesive, and/or additional mechanical connection systems. The process may include precise and systematic force and distance control features that pre-seat the battery pack brick precisely into the battery case and pre-seat battery cells into the carriers. Thus, the battery cover frictional welding installation process may manage multiple interference surfaces, joining them in a single process. The multiple interference surfaces may include, without limitation: lid-to-base; lid-to-brick; and brick-to-base. This may provide gains in efficiency, simplified process flow during manufacturing, cost reduction, and reduction in bill of materials.

As frictional welding proceeds, lid may be compressed and retained within precise tolerances and retains, by interference fit, the battery brick and components securely and precisely positioned. Advantageously, this may eliminate the need for additional parts such as fasteners, adhesives, brackets, spacers, and filler materials. Force and distance control process may pre-seat both the brick 302, 904 into case 402, 914 and battery cells 102, 312 into carriers 104, 250, 316 in order to prepare the parts for the frictional welding to ensure that all of the components meet the design intent drawings and stay within allowable tolerances.

In some embodiments, an algorithm may utilize a serial number assigned to each module to arbitrate a master battery module within an array of modules. The master battery module may communicate aggregated data about the module array to a host vehicle so that the host vehicle views the assembly of batteries as a single module. Multiple communication protocols may be utilized (such as eleven bit and twenty-nine bit identifiers) so that the host does not receive all of the additional communications between the slave modules and the master.

During synchronization at startup, battery cells 102, 312 may communicate with one another and algorithm may designate a single module as master. For example, algorithm may designate module with the lowest serial number to be master. In the event of a loss of communication with the master, the next lowest serial number cell may be designated as the new master and the new master may take over communicating with the host vehicle. Aggregating communication through a master module may be more cost-effective by eliminating the need for additional low voltage communication buses while also providing more robust communication.

In various embodiments, multiple low voltage communication ports and networks may be used in order to reduce bus loading. Bus loading is often an issue in passenger vehicles. In industrial applications, this should not be as substantial an issue due to frequency of message transmission bus load impact is approximately 1% per module in industrial applications.

Consistent with disclosed embodiments, when external low voltage communication lead 408, 920 is disconnected, as a safety feature, battery module 602 may return to a sleep state. In a sleep state, BMS 410, 502, 912 connected to the external terminals 412, 918 may be configured to cause an open circuit so that there is no voltage at the external terminals 412, 918, thereby withholding power from the vehicle when the battery module and vehicle are not in communication.

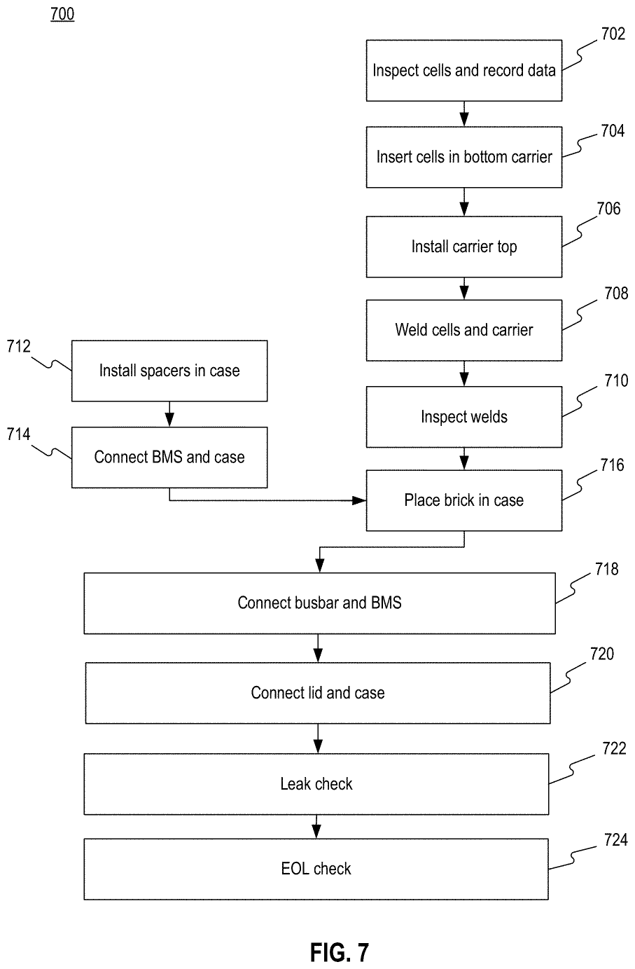

A method of manufacturing a battery module 700 is disclosed. The basic steps of an exemplary method are depicted in FIG. 7. It is to be understood that the steps comprising the method may be varied, combined, omitted, reordered, or otherwise altered according to the target specifications of the battery module.

At step 702, before inclusion within a battery module, battery cells 102, 312 may be inspected 702. Inspection 702 may include human or automated verification that each cell is free from visual defects, structural damage, that each cell is within physical measurement specifications, that each cell meets material composition or chemical specifications, and that each cell is overall suitable for inclusion in a battery module.

As part of the inspection step 702, data associated with each cell may be collected. Data associated with each cell may include, without limitation: observed or measured defects; physical dimensions; weight; material; state of charge; origin (e.g., supplier or geographic location); or other observed or measured characteristic of the cell.

In step 704, cells 102, 312 are placed into first carrier 104, 316. Cells may be oriented in order to facilitate connection of groups of cells in series and/or parallel. First carrier 104, 316 may be prefabricated or partially prefabricated in order to received and hold cells in place by interference fit. First carrier 104, 312 may include mechanical and/or electrical connections between the cells. For example, first carrier may include busbar 318, 320 with tabs 810 for connection between individual cells and the busbar 802 via fusible links 804. Fusible links 804 may be prefabricated or adapted to position fusible links at a specified position with respect to inserted cells 102 to facilitate connection (i.e., welding).

At step 706, second carrier 202, 310 is installed. Second carrier 202, 310 may be prefabricated or partially prefabricated in order to received and hold cells 102 in place by interference fit. Second carrier 202, 310 may include mechanical and/or electrical connections between cells 102, 312. Second carrier 202, 310 may include busbar 204, 310 with tabs 810 for connection between individual cells 102, 312 and the busbar 204, 310, 802 via fusible links 210, 804. Fusible links 210, 804 may be prefabricated or adapted to position fusible links 210, 802 at a specified position with respect to cells 102, 312 to facilitate eventual connection (i.e., welding). Additionally, additional components or materials may be used further stabilize, protect, or provide the desired function, shape, or aid in the manufacturing process. For example, the manufacturer may insert foam or other padding to assist the carrier pieces in holding the cells in place and to protect against damage from vibration during assembly.

Consistent with disclosed embodiments, mechanical force may then be applied to interconnect first carrier 104, 250, 316 and second carrier 202, 310. The manufacturer may apply pressure to the separate components to force them together so that they are held in place by interference fit between battery cells 102, 312 and carrier 104, 202, 250, 310, 316. The manufacturer may apply consistent force so that the carriers are driven to a fixed distance apart, with the cells 102, 312 in between. The fixed distance may be standard with a limited tolerance threshold, such as +/−0.15 mm. In some embodiments, carriers 104, 202, 250, 310, 316 may include integrated features such as pillar 924 for aligning first carrier 104, 250, 316 and second carrier 202, 310. Additionally, pillars 324 integral to first carrier 104, 250, 316 may be configured to interact with corresponding pillars 324 integral to second carrier 202, 310 in order to hold components at a fixed and consistent distance apart, with the cells 102, 312 in between.

At strep 708, cells 102, 312 may be electrically connected to busbars 204, 252, 250, 304, 316 of first and second carriers 104, 202, 250, 310, 316. Cells 102, 312 may be connected to busbars 204, 252, 304, 320, 404, 802 by laser welding to connect tabs 810 in the busbars 204, 252, 304, 320, 404, 802 and cells 102, 312. Laser welding may include using a laser to heat thin materials in order to form a welded connection. The laser welding process may also apply a force to ensure that an intimate connection is achieved during welding. Force may be applied to drive contact to a specified pressure. A laser may provide a heat source for securing the welds.

Laser welding provides a concentrated heat source, allowing for precise, narrow, and strong welds in greater quantity, speed, and consistency. Care must be taken to weld precisely so that cells 102, 312 are not damaged or breached. Laser parameters are adjusted to ensure a secure connection between cells 102, 312 and busbar 204, 252, 304, 320, 404, 802 according to the desired specifications. Laser parameters may include type, power, speed, defocus, spot size, weld head location, foot force, weld depth, strength, pulse width, frequency, or any other adjustable setting. Depending on the specific equipment used by the manufacturer, variances in beam size, head type, and generator may result in variance in the resulting welds and the quality and durability thereof. Therefore, it is preferred to work within a power range of 200 W to 25 kW and a speed range of 100 mm/s-1000 mm/s in order to provide a secure weld that will endure for the life of the battery module. The laser welding process may vary as a function of numerous parameters including laser power, welding speed, focal distance, spot size, applied force, and surface cleanliness. Typical ranges for these parameters include 100-2000 W for laser power, 100-1500 mm/s for welding speed, −5-5mm for focal distance, 0-300% for spot size, 5-100N of applied force, and 30-100 mJ/m² for surface cleanliness.

Laser welding cells 102, 312 to the nickel-plated steel busbar tab 810 enables repairability of the weld while avoiding high scrap costs. The type of laser needed may depend on the desired specifications of the battery module and desired weld. The type of laser may vary by laser type or manufacturer. Other variables that influence weld performance and repeatability may include contact pressure between welded surfaces, weld debris removal method, beam width, fiber width, focal point depth, focal length from focusing lens, and use of protection gasses.

The configuration of the fusible link preferably permits the resulting weld to be tested. If the weld fails, the surface area of the fusible link is large enough to accommodate additional or adjacent repair welds, thus, avoiding high scrap costs.

The number and shape of welds may vary according to individual desired specifications. By way of example, four welds 808 may be used in a straight line around the fusible link to connect busbar tab 810 and cell 102, 312 physically and electrically. Multiple welds may be employed to provide redundancy in order to increase the lifecycle of the battery and prevent loss of contact over time through ordinary use. Any combination of one or more welds in any shape is possible subject only to the specified range for resistance because the welds are not structural and need only provide electrical and physical connection. Additional weld patterns are illustrated in FIG. 8B.

At step 710, welds resulting from step 708 are inspected. Welds may be tested by inserting probe through hole or gap 806 in busbar tab 810 to touch cell 102, 312 and busbar 204, 252, 304, 320, 404, 802. An exemplary embodiment is shown in FIG. 8A depicting gap 806 in busbar 802 and tab 810. This configuration may facilitate checking the joint resistance of the material and the weld. Each weld may be tested simultaneously or sequentially. For example, if battery module contains 112 battery cells, 112 probes may be used simultaneously, a smaller number of probes multiple times, or a single probe 112 times. The manufacturer can test all of the welds and batch repair any defects or probe a subset and follow with repair. Weld resistance may be checked to ensure that resistance is within the specified range. If a measured resistance is outside a specified range, then the manufacturer may repair or replace the defect(s).

The disclosed method may establish mechanical and electrical connection without impairing resistance or balance of the resulting circuit. Testing welds may facilitate balancing. Balancing cells in series and groups of cells in parallel may prevent high resistance from developing that would otherwise cause imbalance, overheating, and failure of fusible link.

In some embodiments, fire retardant sheet, such as FORMEX®, may be applied over busbar 204, 404. Sheet may be included to increase safety and stability. For example, the sheet may be V0 compliant according to the plastics flammability standard released by Underwriters Laboratories (UL-94), providing some fire-retardant capability. The sheet may also be inserted to isolate the cells/modules from other components.

At step 712, outer case 402, 914 is prepared to receive brick 302. Outer case 402, 914 may hold the brick 302, cells 102, 312, or other components securely by interference fit, without the need for fasteners or adhesives. One or more elements or materials may be inserted into outer case 402, 914 to help maintain compression within the battery case. For example, the manufacturer may insert a layer or spacer 926 comprising foam or other suitable material, according to the design specifications. Inserted elements or materials may protect the case and cells from damage due to the manufacturing process or in service.

At step 714, BMS 410, 502, 912 is installed on the inside of outer case 402, 914. BMS 410, 502, 912 may include terminals 412, 918 for connecting battery to external load, such as vehicle. Terminals 412, 918 may extend through the wall of outer case 402, 914. Terminals may be inserted through opening in wall of outer case and be secured by interference fit with a nut, or other secure suitable connection integrated into a terminal post. In some embodiments, component or material may be inserted to create a seal between the inside of the outer case and the environment. For example, the manufacturer may use an O-ring between the outer wall of the case and the terminal in order to prevent environmental elements such as liquids and dust from entering battery module.

BMS 410, 502, 912 may include a low voltage connection 408, 920 for communication between the BMS 410, 502, 912 and a vehicle. Low voltage connection 408, 920 may extend through wall of outer case 402, 914. A nut or other suitable fastener may be used to secure and seal external connection with low voltage connector 408, 920.

At step 716, brick 302 is inserted into case 914 by applying force through brick 302, 904 onto posts 916 on case 914 so that the components are held in place by interference fit and brick 302, 904 is mechanically joined to case 914. FIG. 9 depicts posts 916 for guiding brick 302, 904 into position within battery case 914. Posts 916 interact with brick 302, 904 to fix brick 302, 904 in place inside battery case 914 via interference fit.

At step 718, busbar 204, 252, 250, 310, 316 is connected to BMS 410, 502, 912 through leads 208, 254, 406, 910. Busbar 204, 252, 250, 310, 316 may be connected to BMS 410, 502, 912 at positive terminal 412a, 918a and negative terminal 412b, 918b. Busbar 204, 252, 250, 310, 316 and BMS 410, 502, 912 may be connected by laser weld, solder, fastener, or any other suitable method or component for mechanically and electrically connecting battery components. FIG. 2 depicts current collector 206 allowing for use of fastener or laser weld to connect to BMS 410.

Step 718 may further include attaching sensing circuit leads and BMS 204, 252, 250, 310, 316. FIG. 4 depicts sensing circuit 406 attached to BMS 410. Consistent with disclosed embodiments, pressure foot may facilitate intimate connection between busbar 204, 404 and BMS 410 internal terminals. This intimate contact may provide contact point for laser welding of busbar 204, 404 to BMS 410 internal terminals. In some embodiments, the BMS terminals may be configured to utilize fasteners in order to improve robustness, act as process aids, or substitute for laser welds as a connection between the busbar 204, 404 and BMS 410.

At step 720, the lid 902 is installed on case 914. Lid 902 may be attached to case 914 case using a fastener or adhesive. Alternatively, the lid 902 may be frictionally welded to fuse lid 902 to case 914. Advantageously, friction welding provides a robust, sealed attachment of lid 902 to case 914 without increasing the bill of materials, reducing production cost.

At step 722, welding of lid 902 to case 914 from step 720 is checked to meet design and product specifications. Any suitable non-destructive testing may be employed to ensure battery module 602 is sealed and protected from incursion of liquids, dust, and other environmental elements. For example, opening 922 in battery module 602 may be used to pressure test the module at 3 PSI gauge. The specific pressure used for testing may vary according to design and product specifications. If an improper seal or leak is detected, any faulty welds may be repaired. After testing for leaks, vent may be installed in opening 922 used for testing. Vent may allow for pressure equalization during use of the battery and serve as a rupture valve.

At step 724, end-of-line (“EOL”) tests are performed. EOL tests may include any automated or manual testing of the overall functionality or quality of the final product. For example, the manufacturer may verify that the low voltage communicator 408, 920 is working. The manufacturer may verify that the resistances of the welds by applying a pulse.

Consistent with disclosed embodiments, battery cells may be connected ad modules assembled without fillers or fasteners. The disclosed components may be interconnected as described herein using at least friction welding, laser welding, adhesives, held in place by interference fit, or methods for forming permanent electrical and mechanical connections.

The descriptions of the various embodiments of the present disclosure have been presented for purposes of illustration and are not intended to be exhaustive or limiting. Multiple modifications and variations of the disclosed embodiments will be apparent to those of ordinary skill in the art, without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Certain features of the present disclosure, which are, for clarity, described in the context of separate embodiments, may also be combined in a single embodiment. Conversely, various features of the invention, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A battery module having multiple cells, comprising:
a first carrier configured to hold ends of each of a plurality of battery cells;
a second carrier configured to hold opposite ends of each of the plurality of battery cells;
a case partially enclosing the first carrier and the second carrier;
first busbar having one or more fusible links per cell, integrally formed therein, the first busbar cooperating with the first carrier and mechanically and electrically connected to one or more cells by laser welding;
second busbars having fusible links integrally formed therein cooperating with the second carrier and mechanically and electrically connected to the cells by laser welding;
a lid cooperating with the case to fully enclose the first carrier, second carrier, busbars, and cells; and
terminals extending through the case to provide electrical connection to the plurality of cells.

2. The battery module of claim 1, further comprising a battery management system (BMS) attached to the interior of the case, wherein the BMS is mechanically and electrically connected to the first busbar and second busbar.

3. The battery module of claim 2, further comprising a positive terminal and a negative terminal connected to the BMS within the case, wherein the positive terminal and the negative terminal extend through the case.

4. The battery module of claim 1, wherein a plurality of battery cells is held in place by the first carrier and second carrier via interference fit.

5. The battery module of claim 4, wherein the first carrier and second carrier are held in place within the case without fasteners.

6. The battery module of claim 1, wherein the case and lid are joined using friction welding.

7. The battery module of claim 1, wherein the first busbar includes a first stamped fusible link for connection between the first busbar and the first end of the plurality of battery cells.

8. The battery module of claim 7, wherein the second busbar includes a second stamped fusible link for connection between the second busbar and the second end of the plurality of battery cells.

9. The battery module of claim 8, wherein the first stamped fusible link and the first end of the plurality of battery cells are connected using laser welding.

10. The battery module of claim 9, wherein the second stamped fusible link and the second end of the plurality of battery cells are connected using laser welding.

11. A method for assembling a battery module, comprising:
inserting a plurality of battery cells in a bottom carrier;
holding the plurality of battery cells between the bottom carrier and a top carrier;
connecting a first end of the battery cells to a first busbar integrated within the bottom carrier;
connecting a second end of the battery cells to a second busbar integrated within a top carrier to form a brick;
connecting a battery management system (BMS) with the interior of a case;
pressure fitting the brick into the case;
connecting the brick to a positive terminal and negative terminal by connecting the first busbar to the positive terminal and the second busbar to the negative terminal;
connecting the positive terminal and the negative terminal to the BMS; and
attaching a lid onto the case.

12. The method of claim 11, wherein the plurality of battery cells is between the bottom carrier and the top carrier by interference fit.

13. The method of claim 11, wherein the first end of the battery cells is connected to the first busbar via laser weld.

14. The method of claim 13, wherein the second end of the battery cells is connected to the second busbar via laser weld.

15. The method of claim 11, further comprising, before connecting the BMS:
inspecting the laser weld connection between the first end of the battery cells and the first busbar; and
inspecting the laser weld connection between the second end of the battery cells and the second busbar;

16. The method of claim 11, further comprising performing a leak check.

17. The method of claim 11, wherein the lid is attached onto the case via friction weld.

18. The method of claim 11, wherein the first busbar includes a first stamped fusible link for connection between the first busbar and the plurality of battery cells.

19. The method of claim 18, wherein the second busbar includes a second stamped fusible link for connection between the second busbar and the plurality of battery cells.

20. The method of claim 11, wherein connecting the BMS with the interior of a case includes mounting the BMS perpendicular to the orientation of the plurality of battery cells.

21. A busbar comprising:
an electrically conducive land;
an tab including a surface for electrical and mechanical connection between the busbar and a first end of a battery cell; and
one or more fusible links electrically and mechanically connecting the tab and the land.

22. The busbar of claim 1, wherein the tab includes a gap.

23. The busbar of claim 1, wherein the tab and the first end of the battery cell are connected using laser welding.

24. The busbar of claim 1, wherein two or more tabs are electrically and mechanically connected to the land by one or more additional fusible links.
